(19) United States
(12) Patent Application Publication
(10) Pub. No.: US 2011/0236302 A1
(43) Pub. Date: Sep. 29, 2011

(54) CATALYST, METHOD FOR PRODUCING THE CATALYST, AND METHOD FOR PRODUCING HYDROGEN USING THE CATALYST

(76) Inventors: Yoshio Hanakata, Yokohama-shi (JP); Takayuki Fukasawa, Yokohama-shi (JP); Naoki Shutoh, Yokohama-shi (JP)

(21) Appl. No.: 12/888,549

(22) Filed: Sep. 23, 2010

(30) Foreign Application Priority Data
Mar. 26, 2010 (JP) 2010--073695

(51) Int. Cl. B01J 23/72; B01J 21/08; B01J 21/04; B01J 21/06; B01J 23/83; B01J 23/888; B01J 23/80; B01J 23/86; B01J 23/745; C01B 3/26

(52) U.S. Cl. 423/651; 502/345; 502/244; 502/346; 502/304; 502/318; 502/343; 502/317; 502/331

(57) ABSTRACT

According to one embodiment, there is provided a catalyst including a first structure including a metal oxide substrate having a pore, and a fine particle including Cu as a main component supported on an inner surface of the substrate facing the pore, and a second structure formed on the outer surface of the first structure and including Cu as a main component. The second structure is formed into a needle with a tip thereof oriented outward from the first structure.

### CROSS-REFERENCE TO RELATED APPLICATIONS

This application is based upon and claims the benefit of priority from Japanese Patent Application No. 2010-073695, filed Mar. 26, 2010; the entire contents of which are incorporated herein by reference.

### FIELD

Embodiments described herein relate generally to a catalyst for reforming methanol to produce hydrogen, a method for producing the catalyst, and a method for producing hydrogen using the catalyst.

### BACKGROUND

In recent years, from the viewpoint of effective utilization of energy, attempts are being made to produce hydrogen using a low temperature heat source (waste heat at 300° C. or lower). In such low temperature range, generally, methanol is used as the hydrogen source.

In a reforming reaction for producing hydrogen from methanol, known Cu—Zn-based catalysts are used as a material for efficiently reforming a fuel to produce hydrogen. The catalyst is, for example, supported on γ-alumina having a large specific surface area. Actually, Cu—Zn-based catalysts are useful because they have a specific surface area more than 100 m²/g, and almost completely reform methanol at temperatures about 250° C. However, not only Cu—Zn-based catalysts but other existing Cu-based catalysts are known to cause the deterioration of catalytic activity after use at a temperature higher than an appropriate range (for example, 350° C.), or after use for a long time. The deterioration of catalytic activity is caused by the decrease of the specific surface area of the catalyst resulting from the growth of Cu particles as an active component.

In addition, existing Cu-based catalysts are susceptible to oxidation. It is known that existing Cu-based catalysts in an activated state exposed to the air cause aggregation or coalescence of Cu particles due to abrupt oxidative reaction accompanied by heat generation, which results in irreversible activity deterioration. Accordingly, when handling an existing Cu-based catalyst, it must be reduced immediately before use in the actual use environment, and a gas line for reduction is required in the plant. In addition, countermeasures to prevent the contamination of oxygen must be taken even after shutdown, which results in the complication and enlargement of the plant.

We have developed and suggested reductively precipitated Cu/alumina-based reforming catalysts which cause little aggregation of Cu particles during oxidation after activation, show little deterioration in the reforming performance, and have thermal stability. For example, JP-A 2008-207070 (Kokai) discloses a reductively precipitated Cu-based reforming catalyst. The catalyst is obtained through burning in an inert atmosphere to form a complex oxide CuAlO₂, followed by hydrogen reduction of the complex oxide thereby precipitating Cu. According to the method, Cu is more uniformly and highly precipitated compared to a reduction of CuAl₂O₄ burned in the air, whereby a highly active catalyst can be produced. However, the catalyst thus obtained shows insufficient reaction activity at lower temperatures (250° C. or less), so that the low temperature activity must be improved with the durability maintained. In addition, in consideration of recycling of the catalyst, it is desirable that the object be achieved with a more simple elemental composition.

### BRIEF DESCRIPTION OF THE DRAWINGS

FIG. 1 is a schematic cross-sectional view of a prior art catalyst;

FIG. 2 is a schematic cross-sectional view of the catalyst obtained according to an embodiment; and

FIG. 3 is a transmission electron microscope (TEM) image of the catalyst obtained according to an embodiment.

### DETAILED DESCRIPTION

In general, according to one embodiment, there is provided a catalyst including a first structure including a metal oxide substrate having a pore, and a fine particle including Cu as a main component supported on an inner surface of the substrate facing the pore, and a second structure formed on the outer surface of the first structure and including Cu as a main component. The second structure is formed into a needle with a tip thereof oriented outward from the first structure.

The embodiments are explained below in reference to the drawings.

In the catalyst according to one embodiment, the metal oxide substrate has a first feature that it comprises pores developed internally and communicating with the outside air, and fine particles comprising Cu as a main component are precipitated on the inner wall facing the pore, and the second feature that spiny particles are formed on the catalyst surface. Owing to these two features, the fine particles comprising Cu as a main component have large surface areas exposed to outside air, whereby high activity is achieved.

In the reductively precipitated Cu-based reforming catalyst according to one embodiment, the metal oxide substrate may be alumina. The alumina includes α-alumina or γ-alumina. According to the present embodiment, γ-alumina is used as a raw material, and Cu is precipitated by reduction to obtain the first structure. Through the use of γ-alumina, a catalyst having the above-described two features can be obtained.

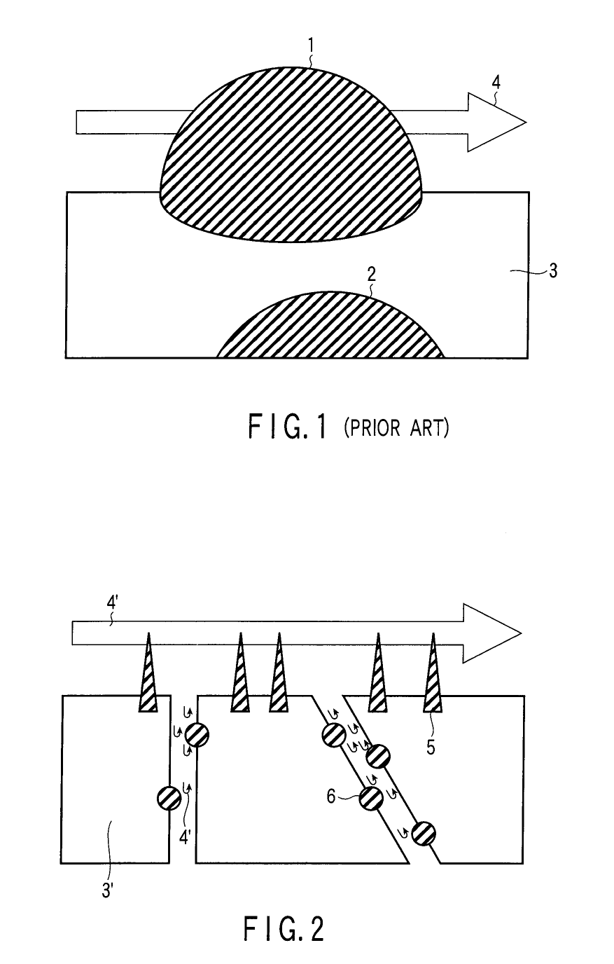

FIG. 1 is a partially enlarged cross-sectional view of the catalyst comprising α-alumina as the metal oxide substrate. FIG. 2 is a partially enlarged cross-sectional view of the catalyst comprising γ-alumina as the metal oxide substrate.

The first feature of the catalyst according to one embodiment is described below. When α-alumina is used as a raw material, an alumina 3 (metal oxide substrate) after reductive precipitation of Cu has few pores, and Cu precipitates in the form of fine particles 2 on the outermost surface 1 of the alumina 3 or inside the alumina 3 (FIG. 1). On the other hand, when γ-alumina is used as a raw material, the alumina 3′ comprises pores developed internally and communicating with outside air 4′, and Cu fine particles 6 are precipitated on the inner wall facing the pore (FIG. 2). In FIG. 1, the fine particles on the outermost surface of the alumina 3 are exposed to the outside air 4, but the fine particles 2 within the alumina 3 will not be exposed to the outside air. On the other hand, in FIG. 2, the pores are communicated with the outside air 4′, so that the fine particles 6 in the pores are readily exposed to the outside air 4′.

When γ-alumina is used as the raw material, spiny particles 5 (second structure) are formed on the surface of the alumina 3′ with the tips projected in a direction opposite to the alumina 3′ (FIG. 2, the second feature). In other words, the second structure is projecting from the edge of the first structure in the cross section of the catalyst. Such spiny particles are not found when α-alumina is used as a raw material (FIG. 1).

As described above, the catalyst made from γ-alumina as the metal oxide substrate comprises fine particles comprising Cu as a main component having large surface areas exposed to the outside air, and thus offers high activity.

When a catalyst is specifically produced using alumina as the metal oxide substrate, firstly, a mixture of copper oxide and γ-alumina is prepared, and then burned under an inactive gas atmosphere or in the air.

The mixture of copper oxide and γ-alumina is preferably in the form of pellets prepared by compression molding, but not limited thereto.

The primary particle size of γ-alumina is not particularly limited to, but preferably 0.1 μm or less, thereby further developing the structure of the first feature.

When the mixture of copper oxide and γ-alumina is burned under an inactive gas atmosphere, at least sintered CuAlO₂ and α-alumina are formed. The sintered CuAlO₂ is in a blue color. When the mixture of copper oxide and γ-alumina is burned in the air, at least a sintered CuAl₂O₄ (in a red brown color) and a sintered α-alumina are formed. The burning temperature is preferably from 850° C. to 1300° C. If the burning temperature is too low, formation of CuAlO₂ and CuAl₂O₄ will be insufficient. On the other hand, if the burning temperature is too high, grain growth occurs, which results in the size reduction of the pores in the first structure. More specifically, the part having the first feature decreases, which results in the decrease of the surface area on which Cu fine particles to be precipitated. From the viewpoint of the burning rate, the burning temperature is particularly preferably from 1100 to 1200° C.

Subsequently, Cu fine particles are reductively precipitated from CuAlO₂ and CuAl₂O₄ (generally referred to as CuAlxOy). The reduction temperature when the Cu fine particles are reductively precipitated from CuAlxOy is preferably from 600° C. to 1000° C. If the reduction temperature is lower than 600° C., reduction is insufficiently achieved, and if the reduction temperature is higher than 1000° C., Cu reductively precipitated may cause aggregation. If Cu aggregation occurs, the pores in the first structure are lessened. The reduction temperature is particularly preferably from 650 to 750° C.

The Cu content in the catalyst is not particularly limited, but is preferably from 1/3 to 1/1, in terms of the molar ratio of Cu/Al. If the molar ratio is smaller than 1/3, the amount of Cu is insufficient, which results in insufficient activity. If the molar ratio is greater than 1/1, it exceeds the stoichiometry of CuAlO₂. Therefore, some portions of Cu do not react with Al during burning to form large pieces of Cu upon reduction, and absorb adjacent fine structures of Cu. The molar ratio is particularly preferably from 2/5 to 4/5. If the molar ratio is from 4/5 to 1/1, Cu is not left stoichiometrically, but can be partially left because the reaction may be hindered by nonuniformity. In addition, Al is preferably partially left, because the Al forms a strong and porous α-alumina skeleton upon burning, and contributes to the improvement of the strength of the whole catalyst and the gas diffusion within the catalyst particles.

The above-described first feature comprising developed pores means that the alumina structure has a large surface area and small bulk areas. Therefore, the proportions of the non-sintered alumina remaining after burning of CuAlxOy and the alumina having a disordered structure remaining after reduction and desorption of Cu are high on the surface of the alumina structure. The acid points formed in the disordered structure are likely involved in the growth of spiny particles.

On the other hand, if Cu is simply supported on γ-alumina by impregnation, suppression of aggregation of fine particles, which is an advantage of a reductively precipitated catalyst, will not be achieved. Therefore, spiny particles do not grow even if acid points are present, and the aggregation and overgrowth of the fine particles will be dominant.

Accordingly, the spiny particles as the second feature are considered to be greatly related to the developed pores as the first feature.

In the present embodiment, in principle, the raw material other than γ-alumina may be used. More specifically, the raw material may be other metal oxide such as SiO₂, TiO₂, ZrO₄, CeO₂, or WO₃ as long as it satisfies the following three conditions: (1) it forms a complex oxide with Cu; (2) it gives the complex oxide of (1) a specific form of the first feature, or produces fine particles of the raw material; and (3) it develops properties of an acid when the atomic arrangement is disordered.

The metal oxide satisfying these conditions likely provides the first and second features as long as it is contained as a main component in the first structure. Accordingly, the metal oxide may comprise two or more metal oxides selected from alumina, SiO₂, TiO₂, ZrO₄, CeO₂, and WO₃, and may comprise a secondary component other than these metal oxides.

The reductively precipitated Cu-based reforming catalyst according to the present embodiment may contain, for example, Fe, Cr, or Zn as the co-catalyst of Cu. The addition method may be, for example, (A) a method wherein the co-catalyst is added before burning CuAlxOy, (B) a method of impregnating the burned CuAlxOy with a compound of any of the above metal such that the metal is supported on the CuAlxOy, and then precipitating Cu, or (C) a method of achieving the impregnation and support after reductive precipitation of Cu. However, according to the methods of (A) and (B), the added element may react with acid points which are necessary for the formation of Cu-containing spiny particles, to hinder the growth of the spiny particles. Therefore, the addition amount of the co-catalyst is preferably 1% or less of Cu in terms of the molar ratio.

The particles of the second structure according to the present embodiment are mostly spiny, and may partially contain not spiny particles, but unguiform or velvety particles.

The present catalyst favorably produces hydrogen through steam reforming of methanol, and may be combined with other catalyst. For example, the combination of the catalyst with a solid acid which hydrolyzes dimethyl ether achieves steam reforming of dimethyl ether. The example is particularly preferred because the acid points formed in the region having a disordered structure help the solid acid catalyst for hydrolysis. However, the combination is not limited to the example.

The embodiments are explained in detail below with reference to Examples. However, the embodiments are not limited to these examples.

### EXAMPLES

10 g of copper oxide and 12.8 g of γ-alumina powder having an average primary particle size of less than 0.1 μm were weighed, and thoroughly mixed in a mortar (Cu/Al=1/2). Subsequently, the mixture was formed into five pellets using a tablet press having a diameter of 21 mm, the pellets each having a weight of about 4.5 g. The pellets were burned for 2 hours at 1150° C. in an argon flowing atmosphere, thereby obtaining a sintered material A. The result of X-ray diffraction (XRD) analysis indicates that the sintered material A is a mixture of CuAlO₂ and α-alumina. Two pellets of the sintered material A were ground and classified to prepare 5 g of particles having a particle size of 0.355 to 0.71 mm, and the particles were reduced for 5 minutes at 700° C. in a hydrogen flow at 500 mL/minute, to obtain the catalyst of Example 1.

The catalyst of Example 2 was obtained in the same manner as in Example 1, except that γ-alumina having an average particle size of approximately 1 μm, which was obtained by burning aluminum hydroxide at 600° C. for 1 hour, was used as the raw material, in place of the γ-alumina having an average primary particle size of less than 0.1 μm.

The catalyst of Example 3 was obtained in the same manner as in Example 1, except that 0.05 g of iron oxide (III) was additionally added as the raw material.

The catalyst of Example 4 was obtained in the same manner as in Example 1, except that 0.05 g of chromic oxide was additionally added as the raw material.

Another pellet of the sintered material A was impregnated with an aqueous solution which was prepared by dissolving 0.072 g of zinc nitrate hexahydrate in 0.8 g of water at a Zn/Cu ratio of 1/100, dried at 120° C., and then burned at 500° C. for 2 hours. The pellet thus obtained was ground and classified to prepare 2.5 g of particles having a particle size of 0.355 to 0.71 mm. The particles were reduced at 700° C. for 5 minutes in a hydrogen flow at 500 mL/minute, to obtain the catalyst of Example 5.

The catalyst of Comparative Example 1 was obtained in the same manner as in Example 1, except that α-alumina having an average particle size of 0.3 μm was used as the raw material, in place of γ-alumina.

The catalyst of Comparative Example 2 was obtained in the same manner as in Example 1, except that α-alumina, which was prepared by thermally treating γ-alumina powder at 1100° C. for 5 hours, was used as the raw material, in place of γ-alumina.

In the evaluation test, 2 g of the catalysts was individually charged into a fixed bed flow pipe reactor, a mixed solution comprising 32 g of methanol and 36 g of water was passed at a flow rate of 0.16 mL/minute, together with a nitrogen gas as the internal standard at a flow rate of 50 mL/minute, thereby carrying out reaction at 225° C. At the gas exit, unreacted portions of water and methanol were removed by an ice cold trap, and then the total hydrogen yield was analyzed by TCD (thermal conductivity detector) using nitrogen as the internal standard. Formula 1 is used for the analysis.

Total hydrogen yield (L/Hr)=50/1000×(hydrogen concentration determined from TCD)/(nitrogen concentration determined from TCD)×60 <Formula 1>

The catalyst performance was compared based on the comparison of the hydrogen yield for a catalyst unit volume. Formula 2 was used for determining the hydrogen yield.

Hydrogen yield for a catalyst unit volume (L/Hr/L-Cat)=total hydrogen yield (L/Hr)/total catalyst volume (L) <Formula 2>

The evaluation results are listed in Table 1.

TABLE 1

| | Catalyst | | | | | | |
|---|---|---|---|---|---|---|---|
| | | | | | | Comparative | Comparative |
| | Example 1 | Example 2 | Example 3 | Example 4 | Example 5 | Example 1 | Example 2 |
| Hydrogen yield | 3830 | 3120 | 3980 | 3850 | 4210 | 2850 | 2860 |
| for a catalyst | | | | | | | |
| unit volume | | | | | | | |
| (L/Hr/L-Cat) | | | | | | | |

The hydrogen yield in Example 1 was about 25% higher than that in Comparative Example 1.

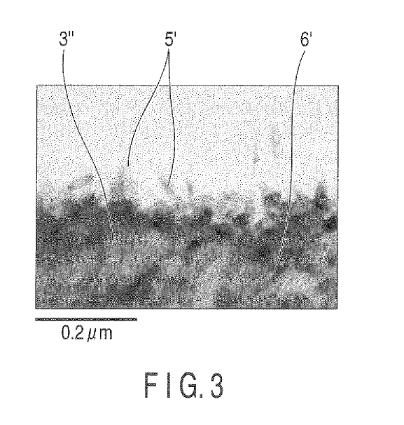

The Transmission Electron Microscope (TEM) image (partially enlarged view) of Example 1 is shown in FIG. 3. Fine particles 6′ precipitated on the inner walls facing the pores in the alumina 3″ and spiny particles 5′ on the surface were observed. The result of TEM/EDX (energy dispersive X-ray spectroscopy) indicates that both of the fine particles 6′ and the spiny particles 5′ are Cu oxides, and formed by reoxidation of once reduced Cu in the air.

Example 1 was subjected to ammonia TPD (temperature programmed desorption) measurement, and found to have acid points having a clear peak in the vicinity of 720° C. The acid points were not observed for Comparative Example 1.

Comparative Example 2 used the same raw material as Example 1, but γ-alumina was converted into α-alumina before simply mixed with copper oxide. The hydrogen yield was lower in Comparative Example 2. The hydrogen yields in Comparative Example 2 and Comparative Example 1 using other α-alumina as the raw material were almost the same. These results suggest that what contributes to the improvement of the hydrogen yield is not the effect of impurities in the raw material γ-alumina, but the fine powder form of γ-alumina.

The catalysts of Example 1 and Comparative Example 1 were forcibly degraded by thermal treatment at 800° C. for 5 hours in a hydrogen flow, and then the hydrogen yield was evaluated. The hydrogen yields for catalyst unit volumes were 3240 and 2250 L/Hr/L-Cat, indicating that the hydrogen yield in Example 1 after thermal treatment was higher than that in Comparative Example 1 without thermal treatment. In Comparative Example 1, the hydrogen yield for a catalyst unit volume after thermal treatment at 800° C. for 5 hours was 21% lower than that before thermal treatment, while 15% lower in Example 1. These results suggest that the catalyst of Example 1 is resistant to heat.

5 g of the catalyst of Example 1 and 5 g of γ-alumina were weighed, thoroughly mixed in a mortar, and then formed into two pellets of a dimethyl ether reforming catalyst using a tablet press having a diameter of 21 mm, the pellets each having a weight of 4.5 g. The two pellets of the catalyst for reforming dimethyl ether were ground and classified to prepare 5 g of dimethyl ether (DME) reforming catalyst particles (Example 6) having a particle size of 0.355 to 0.71 mm. 2 g the catalyst particles of Example 6 and a mixed gas comprising DME:water:nitrogen=1:4:1 as the raw material were subjected to reforming test; dimethyl ether was converted into methanol, and then into hydrogen at a SV (space velocity) of 2100/hr and a temperature of 300° C. The conversion ratio from dimethyl ether to hydrogen was 99% or more, and the hydrogen yield was more than 2000 L/Hr/L-Cat, indicating good reforming performance.

The above facts suggest that the catalyst having the first and second features has excellent heat resistance and oxidation resistance, and efficiently gives hydrogen.

According to the above-described embodiments or examples, a reductively precipitated Cu/alumina methanol reforming catalyst having excellent heat resistance and oxidation resistance and improved activity, a method for producing the catalyst, and a method for producing hydrogen using the catalyst can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A catalyst comprising:
a first structure comprising a metal oxide substrate having a pore, and a fine particle comprising Cu as a main component supported on an inner surface of the substrate facing the pore; and
a second structure formed on an outer surface of the first structure and comprising Cu as a main component,
the second structure being formed into a needle with a tip thereof oriented outward from the first structure.

2. The catalyst according to claim 1, wherein the metal oxide substrate comprises a metal oxide selected from the group consisting of alumina, silica, titania, zirconia, ceria, and tungsten oxide.

3. The catalyst according to claim 1, wherein the fine particles in the first structure comprises, besides the main component Cu, at least one secondary component selected from the group consisting of O, Zn, Cr, and Fe.

4. The catalyst according to claim 1, wherein the second structure comprises, besides the main component Cu, at least one secondary component selected from the group consisting of O, Zn, Cr, and Fe.

5. A method for producing a catalyst, comprising:
forming a complex oxide CuAlxOy by burning a mixture of γ-alumina having an average particle size of 0.1 μm or less and copper oxide; and
forming a Cu/alumina complex by reducing the complex oxide CuAlxOy to precipitate Cu.

6. A method for producing hydrogen, comprising producing hydrogen from methanol using the catalyst according to claim 1.
